(19) United States
(12) Patent Application Publication
(10) Pub. No.: US 2009/0200946 A1
(43) Pub. Date: Aug. 13, 2009

(54) Method For Power Supplying Of A Plurality Of Cascade Connected Light Sources

(75) Inventor: Gianni Facchini, San Carlo (Ferrara) (IT)

Correspondence Address: WILLIAM J. SAPONE;COLEMAN SUDOL SAPONE P.C., 714 COLORADO AVENUE, BRIDGE PORT, CT, 06605, US

(73) Assignee: O.C.E.M. S.P.A., S. Giorgio di Piano (Bologna) (IT)

(21) Appl. No.: 12/304,384

(22) PCT Filed: Jun. 12, 2007
(86) PCT No.: PCT/EP07/55778

§ 371 Date: Dec. 11, 2008

(30) Foreign Application Priority Data
Jun. 13, 2006 (IT) BO2006A 000456

(51) Int. Cl. H01K 1/62

(52) U.S. Cl. 315/36

(57) ABSTRACT

According to a method for supplying a plurality of cascade connected light sources including, a control signal (k) is sent to a supply apparatus (AA). The control signal corresponds to a desired value of light radiation intensity to be emitted by at least a part of said the light sources, An electric current (z) with variable frequency is supplied to the plurality of light sources (SL₁, SL₂ , . . . , SLₙ) so that the lamps (L) of each light source are crossed by the values of current (h) depending on the frequency values of the current (z) supplied to the plurality of light sources. A connection exists between the values assumed by the control signal (k) and the values of the current (h) circulating in the lamps (L) of the light sources (SL₁, SL₂, . . . , SLₙ).

### BACKGROUND OF THE INVENTION

The present invention relates to systems for supplying light sources, such as half-dipped signaling lamps, disposed along airport runways.

### DESCRIPTION OF PRIOR ART

Such supply systems are usually enclosed within more units in an airport and each of them includes: an apparatus, electrically connected to a plurality of cascade-connected, half-dipped signaling lamps, to define a closed loop circuit, aimed at supplying half-dipped signaling lamps with a electric current with variable intensity (considering its efficient value) as a function of the values assumed by a control signal applied to the input of the apparatus; such a control signal, for example, is transmitted from the control tower and defines, on the basis of a prefixed value scale, the lighting level that the runaway must provide according to contingent visibility level (twilight, night, hostile weather conditions, etc.).

Regulations in force concerning the light sources used along the airport runaways impose a light intensity defined on minimum values basis, which according to a known standard can be obtained for example by applying current values of 2.8, 3.4, 4.1, 5.2 and 6.6 amp to an incandescent lamp; in this way, different minimum light values are defined, with which it is possible to lighten the runaways according to their visibility degree (twilight, night, hostile weather conditions, etc.). At present, the above mentioned apparatus supplies the half-dipped signaling lamps exactly with a main current having one of the above mentioned five current values, depending on the control signal; the central electronic unit of each signaling lamp, in turn, supplies (in known way, on a separated, secondary circuit) the lamps, for example LEDs, (Light Emitting Diodes) included in the signaling lamps, with a secondary current, having values depending on the main current, thus defining corresponding values of light emission, which in average are higher than the ones given by the regulations during the whole LED service life.

In other words, the information content of the control signal, representing the request of the runway lighting level, is reported in the five values that the main current, delivered from the apparatus to the plurality of the cascade-connected light sources, can assume. Therefore a 6.6 amp value of the main current corresponds to a secondary current value equal, for example, to thee nominal current of the LEDs (of 350 mA, 700 mA or IA, according to what is currently on the marketplace).

### SUMMARY OF THE INVENTION

The main object of the present invention is to propose a newly conceived method for supplying a plurality of cascade connected light sources, whose implementation allows a substantial reduction of the value of the current supplying the light sources with respect to known solutions, so as to allow a considerable reduction of the resistance losses and consequently, the possibility to reduce the section of the corresponding electric cables being used.

Another object of the invention lies in devising a method for supplying a plurality of cascade-connected light sources, which is characterized by a number of simple and essential steps, whose implementation costs are relatively low with respect to the advantages to be obtained.

The above mentioned objects are obtained, in accordance with the contents of the claims, by a method for supplying a plurality of cascade connected light sources, characterized by the following steps:
transmitting to a supply apparatus a control signal corresponding to a value of light radiation intensity which is to be emitted by at least part of said light sources;
supplying, by said supply apparatus, an electric current, with constant effective value and variable frequency, to said plurality of light sources, so that selected frequency values, or values intervals, of said current are associated to corresponding values of the control signal;
supplying at least one lamp among the lamps included in each of said light sources of said plurality of the light sources, in accordance with values of a current depending on the frequency values of said current supplied to said light sources, an association existing between the values of said control signal and the values of said current circulating in said lamps of the respective light sources.

### BRIEF DESCRIPTION OF THE DRAWINGS

The characteristic features of the invention, not appearing from what has just been said will be better pointed out in the following, in accordance to what is reported in the claims and with help of the enclosed drawings, in which:

FIG. 1 shows a block diagram of a system for power supplying of a plurality of light sources, carrying out the method proposed by the present invention.

### BEST MODES OF CARRYING OUT THE INVENTION

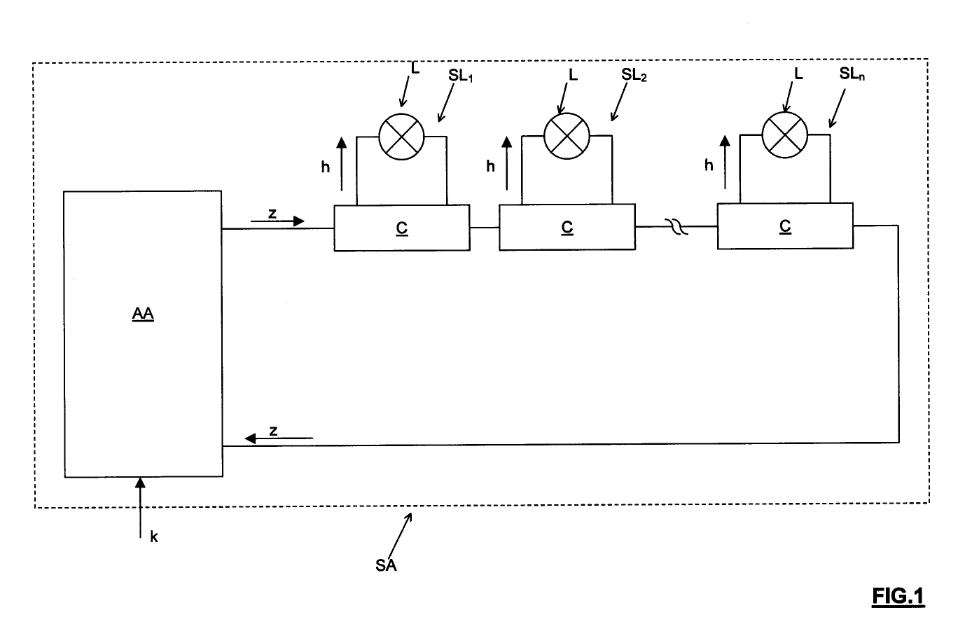

With reference to the enclosed FIGURE, reference SA indicates a supply system as a whole, which is known in itself as far as its constituent parts and its electric-functional connections shown in FIG. 1 are concerned, and which includes an apparatus AA, electrically connected to a plurality of cascade connected light sources SL₁, SL₂, . . . , SLₙ, such as for example half-dipped signaling lamps (known also as light signals), in order to define together with the latter a closed loop circuit. The apparatus AA is aimed at supplying the light signalers SL₁, SL₂, . . . , SLₙ with an electric current z having a constant effective value in the range of e.g. 1 to 1.5 amp, and with a frequency variable in relation to the values assumed by the control signal k applied to the input of the apparatus AA; such a control signal k, as it has already been said, is transmitted from the control tower (not shown) and defines, on the basis of a prefixed value scale, the lighting level that the runaway must have according to contingent visibility level (twilight, night, hostile weather conditions, etc.).

Each of the half-dipped signaling lamps SL₁, SL₂, . . . , SLₙ includes: at least one lamp L. at least a regulation central unit C, which is arranged in series along the above mentioned closed loop circuit, and through which an electric current z passes, whose frequency varies, for example between 50 and 60 Hz. The central unit C is aimed at supplying the lamp L, in known way, on a secondary, separate circuit, according to the values of the current h, which depend on the frequency values of the current z. Therefore, there is a bijective correspondence between the values assumed by the control signal k and the values of the current h circulating in the lamps L of the respective light sources SL₁, SL₂, . . . , SLₙ.

What above, defines the method proposed by the present invention, which includes the following steps:
transmission to the supply apparatus AA of the control signal k, which, as it has already been said, corresponds to a value of light radiation intensity which is to be emitted by the light signalers SL₁, SL₂, . . . , SLₙ;
supply, by the supply apparatus AA, of an electric current z, having constant effective value, but variable frequency, to the plurality of light sources SL₁, SL₂, . . . , SLₙ, so that corresponding values of the control signal k are associated to the determined frequency values, or values intervals, of the current z;
supply of the corresponding LEDs of each light signaler of the plurality of the signaling lamps SL1, SL2, . . . , SLₙaccording to the values of current h depending on the frequency values of the current z, a connection existing between the values assumed by the control signal k and the values of the current h circulating in the LEDs of the respective half-dipped signaling lamps SL₁, SL₂, . . . , SLₙ.

In this way, it is advantageously possible to supply the light signalers SL₁, SL₂, . . . , SLₙ, with a current having a constant effective value, much lower, in average, than the one applied currently in the solutions of known type, equal to e.g. 2.8, 3.4, 4.1, 5.2 e 6.6 amp.

Therefore, a considerable reduction of the resistance power losses is obtained on the half-dipped signaling lamps supply line (in fact of a certain quantity) and the corresponding electric cables can have a section smaller than the ones currently used. Moreover, the reduction of the line current, and consequently of the relative voltage drops, is followed by a considerable reduction of the supply voltage applied to the line ends, which affects positively the electric dimensioning of the corresponding supply apparatus AA.

Another advantage of the invention lies in devising a method for supplying a plurality of cascade connected light sources, which is characterized by a number of simple and essential steps, whose implementation costs are relatively low with respect to the advantages to be obtained.

It is understood that what above has been described as a non limiting example, therefore possible practical-application variants remain within the protective scope of the invention as described above and claimed below.

1. A method for supplying a plurality of cascade connected light sources, characterized by the following steps:
transmitting to a supply apparatus (AA) a control signal (k) corresponding to a value of light radiation intensity which is to be emitted by at least part of said light sources;
supplying, by said supply apparatus (AA), an electric current (z), with constant effective value and variable frequency, to said plurality of light sources (SL₁, SL₂, . . . , SLₙ), so that selected frequency values, or values intervals, of said current are associated to corresponding values of the control signal (k);
supplying at least one lamp (L) among the lamps included in each of said light sources of said plurality of the light sources (SL₁, SL₂, . . . , SLₙ), in accordance with values of a current (h) depending on the frequency values of said current (z) supplied to said light sources, an association existing between the values of said control signal (k) and the values of said current (h) circulating in said lamps (L) of the respective light sources (SL₁, SL₂, . . . , SLₙ).
